(19) United States
(12) Patent Application Publication
(10) Pub. No.: US 2015/0170283 A1
(43) Pub. Date: Jun. 18, 2015

(54) SYSTEM AND METHOD FOR CONDUCTING FINANCIAL TRANSACTIONS

(71) Applicant: Daniel Maldonado, Alpharetta, GA (US)

(72) Inventor: Daniel Maldonado, Alpharetta, GA (US)

(21) Appl. No.: 14/105,931

(22) Filed: Dec. 13, 2013

(51) Int. Cl. G06Q 40/06

(52) U.S. Cl. CPC G06Q 40/06

(57) ABSTRACT

Systems and methods of the present invention include calculating a recorded balance for a plurality of individual investments within the investment portfolio; generating a at least one upper threshold and a lower threshold; periodically applying said upper and lower thresholds to the recorded balance as the recorded balance varies to calculate upper threshold and upper threshold amounts; monitoring fluctuations in the recorded balance against the upper and lower threshold amounts; and generating a preventive notification when the recorded balance exceeds the upper threshold amount or goes below the lower threshold amount.

### FIELD OF THE INVENTION

The present invention relates to data processing systems and methods for conducting financial transactions over a network. More particularly, the present invention relates to systems and methods that enable real active monitoring of all individual or combined account balances.

### BACKGROUND OF THE INVENTION

There is a need in the art to provide to every financial professional with the ability to monitor all portfolio balances on a daily basis and a dynamic way and to receive notifications of changes in market conditions so that he or she can act accordingly upon the receipt of such information. Every financial professional manages considerable amounts of investment accounts, which he/she serves and/or oversees. In any given day, and when market events affect the market value of the accounts, it is physically impossible for the financial professional to monitor every one of the accounts efficiently, and therefore, a system is needed to create periodic notifications of account value changes and/or predetermined thresholds achieved. A plurality of market events (including but not limited to market alerts), economic news and portfolio composition affect accounts and securities differently, so it is important to be able to stay abreast of such changes on a daily basis.

Financial professionals are in a constant struggle to manage investor's accounts and are unable to notify them promptly as a preventive measure. This either to prevent further declines in account value, or to potentially maximize realization of gains and/or other strategies. The general investing public is also in the need and should have the right to act on a timely manner when predetermined thresholds are met. As an example, notifications about margin requirements are notified at the end of the trading day or the next business day, when it is already too late. This happens when the account has gone over fifty percent or more of its lending value. For example, Regulation T of the NYSE governs the lending over securities. If a stock price is $100.00, the investment firm can lend to the investor up to 50% of it, either to buy more stock or withdraw cash. If the stock rises in value, the lending availability grows. If the stock declines in value, the investor has to either deposit more money into the account or sell securities to pay the debt. This can potentially create losses in a down market. In fast moving markets (such as in 2008) it is a challenge to know which accounts are at risk, and usually the Financial Advisor, and the investment firm react to the event, instead of preventing it.

Currently, there is no system available to the investing public nor to financial professionals that can give them the advantage of proactive notifications of market value changes based on different scenarios, such as net money invested, adjusted for withdrawals, gains, losses and transactions, not only to prevent margin calls, but also to take corrective measures before it is even an issue.

Opportunities are also lost if an asset appreciates in value and no action is taken—if any action is agreed or necessary to take—and the investor misses them. Having the system of the present invention in place will greatly diminish or even prevent last minute action on investment portfolios and avoid losses as they have occurred in markets such as in 2000, 2001, 2002, 2007 and 2008 for example. Financial professionals have been unable to act on behalf of the investing public before hand, not because they don't want to, but because no tool has been available. Thus, there is a need in the art for a system that can make the Financial Advisors or investors aware of how changes in market conditions impact their particular accounts consistently.

### SUMMARY OF THE INVENTION

The following presents a simplified summary of the invention in order to provide a basic understanding of some aspects of the invention. This summary is not an extensive overview of the invention. It is intended to neither identify key or critical elements of the invention nor delineate the scope of the invention. Its sole purpose is to present some concepts of the invention in a simplified form as a prelude to the more detailed description that is presented later.

Systems and methods of the present invention include calculating a recorded balance for a plurality of individual investments within the investment portfolio; generating a at least one upper threshold and a lower threshold; periodically applying said upper and lower thresholds to the recorded balance as the recorded balance varies to calculate upper threshold and upper threshold amounts; monitoring fluctuations in the recorded balance against the upper and lower threshold amounts; and generating a preventive notification when the recorded balance exceeds the upper threshold amount or goes below the lower threshold amount.

The following description and the annexed drawings set forth in detail certain illustrative aspects of the invention. These aspects are indicative, however, of but a few of the various ways in which the principles of the invention may be employed and the present invention is intended to include all such aspects and their equivalents. Other advantages and novel features of the invention will become apparent from the following detailed description of the invention when considered in conjunction with the drawings.

### BRIEF DESCRIPTION OF THE DRAWINGS

FIG. 1 illustrates an example of a suitable computing system environment on which features of the disclosed concept may be implemented in accordance with one embodiment of the invention.

FIG. 2 illustrates a flowchart of the method of the present invention in accordance with one embodiment.

### ILLUSTRATIVE EMBODIMENTS OF THE INVENTION

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art.

As will be appreciated by those skilled in the art, portions of the present invention may be embodied as a method, data processing system, or computer program product. Accordingly, these portions of the present invention may take the form of an entirely hardware embodiment, an entirely software embodiment, or an embodiment combining software and hardware aspects. Furthermore, portions of the present invention may be implemented as a computer program product on a computer-usable storage medium having computer readable program code on the medium. Any suitable computer readable medium may be utilized including, but not limited to, static and dynamic storage devices, hard disks, optical storage devices, and magnetic storage devices.

The present invention is described below with reference to illustrations of methods, systems, and computer program products according to embodiments of the invention. It will be understood that blocks of the illustrations, and combinations of blocks in the illustrations, can be implemented by computer program instructions, hardware devices, or a combination of both. These computer program instructions may be provided to a processor of a general purpose computer, special purpose computer, or other programmable data processing apparatus to produce a particular machine, such that the instructions, which execute via the processor of the computer or other programmable data processing apparatus, implement the functions specified in the block or blocks.

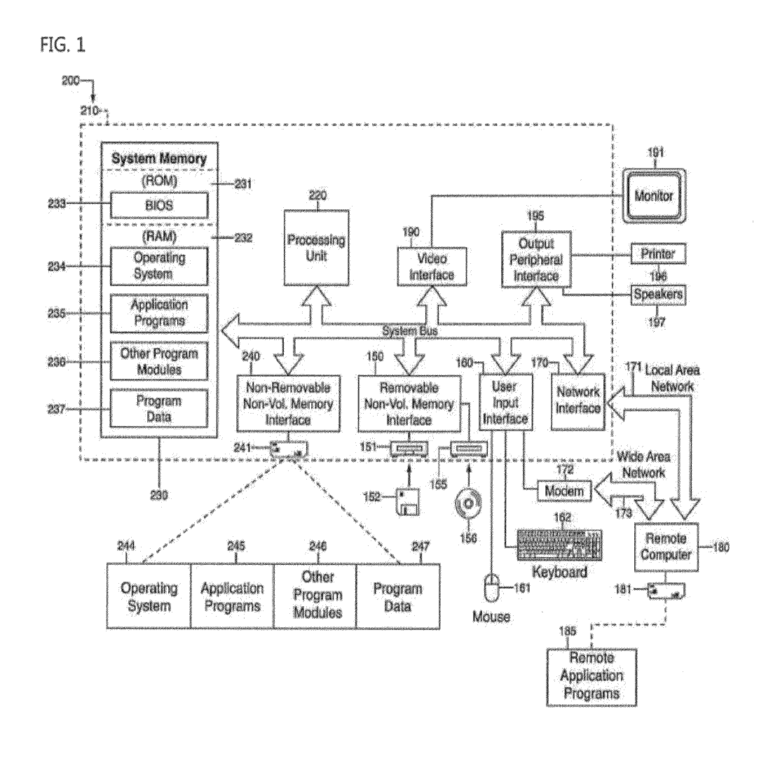

Embodiments of present invention may be implemented on one or more computing devices, including one or more servers, one or more client terminals, including computer terminals, a combination thereof, or on any of the myriad of computing devices currently known in the art, including without limitation, personal computers, laptops, notebooks, tablet computers, touch pads (such as the Apple iPad, SmartPad Android tablet, etc.), multi-touch devices, smart phones, personal digital assistants, other multi-function devices, stand-alone kiosks, etc. An exemplary computing device for implementing a computational device is illustrated in FIG. 1.

FIG. 1 illustrates an example of a suitable computing system environment 200 on which features of the invention may be implemented. The computing system environment 200 is only one example of a suitable computing environment and is not intended to suggest any limitation as to the scope of use or functionality of the invention. Neither should the computing environment 200 be interpreted as having any requirement relating to any one or combination of components illustrated in the exemplary operating environment 200.

The invention is operational with numerous other computing system environments or configurations. Examples of well known computing systems, environments, and/or configurations that may be suitable for use with the invention include, but are not limited to, personal computers, server computers, hand-held, notebook or laptop devices, touch pads, multi-touch devices, smart phones, other multi-function devices, multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by one or more computing devices. Generally, program modules include routines, programs, objects, components, data structures, etc., that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

With reference to FIG. 1, an exemplary system that may be used for implementing the invention includes a computing device 210 which may be used for implementing a client, server, mobile device or other suitable environment for the invention. Components of computing device 210 may include, but are not limited to, a processing unit 220, a system memory 230, and a system bus 221 that couples various system components including the system memory to the processing unit 220. The system bus 221 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computing device 210 typically includes a variety of computer readable media. Computer readable media may be defined as any available media that may be accessed by computing device 210 and includes both volatile and nonvolatile media, removable and non-removable media. By way of example, and not limitation, computer readable media may include computer storage media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computing device 210. Combinations of the any of the above should also be included within the scope of computer readable media.

The system memory 230 may include computer storage media in the form of volatile and/or nonvolatile memory such as read only memory (ROM) 231 and random access memory (RAM) 232. A basic input/output system 233 (BIOS), containing the basic routines that help to transfer information between elements within computing device 210, such as during start-up, is typically stored in ROM 231. RAM 232 typically contains data and/or program modules that are immediately accessible to and/or presently being operated on by processing unit 220. By way of example, and not limitation, FIG. 1 illustrates operating system 234, application programs 235, other program modules 236, and program data 237.

The computing device 210 may also include other removable/non-removable, volatile/nonvolatile computer storage media. By way of example only, FIG. 1 illustrates a hard disk drive 240 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 241 is typically connected to the system bus 221 through a non-removable memory interface such as interface 240, and magnetic disk drive 151 and optical disk drive 155 are typically connected to the system bus 121 by a removable memory interface, such as interface 150.

The drives and their associated computer storage media discussed above and illustrated in FIG. 1, provide storage of computer readable instructions, data structures, program modules and other data for the computing device 210. In FIG. 1, for example, hard disk drive 241 is illustrated as storing operating system 244, application programs 245, other program modules 246, and program data 247. Note that these components can either be the same as or different from operating system 234, application programs 235, other program modules 236, and program data 237. Operating system 244, application programs 245, other program modules 246, and program data 247 are given different numbers here to illustrate that, at a minimum, they are different copies. A user may enter commands and information into the computer 20 through input devices such as a keyboard 162 and pointing device 161, commonly referred to as a mouse, trackball, touch screen, or multi-touch input device. Other input devices (not shown) may include a microphone, joystick, game pad, satellite dish, scanner, movement sensor device such as the Microsoft Kinect or the like. These and other input devices are often connected to the processing unit 220 through a user input interface 160 that is coupled to the system bus, but may be connected by other interface and bus structures, such as a parallel port, game port or a universal serial bus (USB). A monitor 191 or other type of display device may also be connected to the system bus 221 via an interface, such as a video interface 190. In addition to the monitor, computers may also include other peripheral output devices such as speakers 197 and printer 196, which may be connected through an output peripheral interface 195.

The computing device 210 may operate in a networked environment using logical connections to one or more remote computers, such as a remote computer 180. The remote computer 180 may be a personal computer, a server, a router, a network PC, a peer device or other common network node, and typically includes many or all of the elements described above relative to the computing device 210, although only a memory storage device 181 has been illustrated in FIG. 1. The logical connections depicted in FIG. 1 include a local area network (LAN) 171 and a wide area network (WAN) 173, but may also include other networks. Such networking environments are commonplace in offices, enterprise-wide computer networks, intranets and the Internet.

When used in a LAN networking environment, the computing device 210 is connected to the LAN 171 through a network interface or adapter 170. When used in a WAN networking environment, the computer 210 typically includes a modem 172 or other means for establishing communications over the WAN 173, such as the Internet. The modem 172, which may be internal or external, may be connected to the system bus 221 via the user input interface 160, or other appropriate mechanism. In a networked environment, program modules depicted relative to the computing device 210, or portions thereof, may be stored in the remote memory storage device. By way of example, and not limitation, FIG. 1 illustrates remote application programs 185 as residing on memory device 181. It will be appreciated that the network connections shown are exemplary and other means of establishing a communications link between the computers may be used.

In one embodiment, the present disclosure describes a system that provides real active monitoring of all individual or combined account balances. In one embodiment, the system provides or addresses preventive margin notifications. In one embodiment, the preventive margin notifications can prevent a margin call. Other embodiments may include other preventive notifications that are not tied to margins, as margins are not used by every investor. Such other embodiments may also monitor margins, however.

In one embodiment, an account is first opened and at that time the client will decide its upper and lower percentage barriers or thresholds of money invested. When the system disclosed herein is used on an aggregation system, initial costs or values may migrate initially. In an aggregation system accounts are aggregated. For example a household can have 3 accounts for three different reasons. A retirement account, a personal account and a custodian account. If the household market values are aggregated or combined, the entire value may be used as a whole for the purpose of creating the thresholds and/or notifications.

There can be more that one barrier or threshold established for any account or combined/aggregated accounts, either on the downside or the upside. For example, if an upper threshold or barrier is set at 10% of a recorded balance, a financial advisor may sell 10% of stock owned in one company and if a second upper threshold or barrier is set at 20% of a recorded balance, the financial advisor may sell 20% of stock in that company. Alternatively, upon reaching such thresholds, the customer and/or the financial professional may be notified (e.g., sent a preventive notification), and action may be taken by the client in conjunction with the financial professional or advisor. These thresholds may be set during the account opening process but may also be set after accounts have been opened. These barriers or thresholds represent the maximum and minimum percentage amount of the client's account value, and once reached, clients may be notified either by e-mail or telephone phone in order for a specific strategy to be implemented, in accordance with one embodiment. These barriers can be changed during the life of the account to reflect different situations that may affect the financial objectives of the investor.

In one embodiment, once a client has been contacted when a threshold has been reached, if no action is taken it would be noted in the account. If any action is taken, the new balance is recorded and the upper and lower barriers or thresholds will apply to the new recorded balance. The barriers can be changed at any time upon the client's request and/or suggestion by the financial professional.

In order to account for the recorded balance the system will account for all deposits minus withdrawals and to that it will apply the market value changes, either decreases or increases.

For example, if on Day 1 an investor or client deposits $100,000.00 in an investment account, this amount is the recorded balance.

| | |
|---|---|
| Initial deposit/transfer/investment | $100,000.00 |
| Recorded balance | $100,000.00 |

By Day 2 the investor may have agreed on Day 1 with the advisor or financial professional that the investor should be notified if the account value of his investments falls below 10% of his recorded balances and may have also agreed that he will realize gains on market value increases of over 25% of recorded balances.

| | |
|---|---|
| Recorded balance | $100,000.00 |
| Lower Barrier percent | 10.00% |
| Upper Barrier percent | 25.00% |

In this example the lower barrier of the recorded balance is $90,000.00 and the upper barrier is $125,000.00. In one embodiment, the system may cause barriers or thresholds to take effect on Day 2.

| | |
|---|---|
| Recorded balance | $100,000.00 |
| Lower Barrier | $(10,000.00) |
| Low Barrier amount | $90,000.00 |
| Recorded balance | $100,000.00 |
| Upper Barrier | $25,000.00 |
| Upper Barrier amount | $125,000.00 |

The recorded balances are comprised of deposits plus interest and/or dividends (if they remain in the account or are reinvested—all income payed out will not add to recorded balances) plus gains minus withdrawals and or losses.

Upon invested, if the account market value decreases to $90,000.00, the disclosed system may send a notification to the advisor, so he can call the investor, as the lower barrier agreed upon has been reached. After a conversation with the investor it could be agreed that nothing will be done. If the investor deposits additional funds, this will increase the recorded balance.

If $15,000.00 were deposited, the new recorded balance would now be $115,000.00. The market value is $105,000.00. The new lower barrier of the recorded balance is $103,500.00 and the upper barrier is $143,750.00. That is, the barrier or threshold amounts are calculated based on recorded balances.

Assuming that the lower barrier is maintained at 10%, ten percent of $115,000.000 (the recorded balance) is $11,500.00 which for the lower barrier would mean $115,000.00 minus $11,500.00 for a total of $103,500.00.

| | |
|---|---|
| Recorded balance | $115,000.00 |
| Lower Barrier amount | $(11,500.00) |
| New recorded balance | $103,500.00 |

Assuming that the upper barrier is maintained at 25%, twenty five percent of $115,000.000 it is $28,750.00 which for the upper barrier would mean $115,000.00 plus $28,750.00 for a total of $143,750.00.

| | |
|---|---|
| Recorded balance | $115,500.00 |
| Upper Barrier amount | $28,750.00 |
| New recorded balance | $143,750.00 |

If due to further positive market movements, the account market value increases to $128,000.00, the investor may agree with the advisor that he wants to realize a gain in a particular investment that he has in his portfolio, regardless of whether the upper threshold has been met. Using the system disclosed does not constrain investor behavior. He can choose to buy or sell any investment at any time and apply new thresholds as he sees fit.

For example, the investor may sell an investment for $27,000.00 for a total gain of $7,000.00. This event will add to the recorded balance $7,000.00, since $20,000.00 is considered part of the investment's cost basis. The new recorded balance would then be $122,000.00. The market value is $128,000.00. The new lower barrier of the recorded balance is $109,800.00 and the upper barrier is $152,500.00. Upon executing the sale of existing holdings, the investor has recorded a new balance that will track his progress going forward.

| | |
|---|---|
| Market Value | $128,000.00 |
| Previous recorded balance | $115,000.00 |
| Realized Gain | $7,000.00 |
| New recorded balance | $122,000.00 |
| New lower barrier | $109,800.00 |
| New upper barrier | $152,500.00 |

If the investor withdraws $28,000 related to certain investments and the withdrawal results in a loss of $3,000.00, the new recorded balance is $91,000.00. The loss of $3,000.00 is subtracted from the $122,000.00 to a net of $119,000.00. Then the $28,000.00 is subtracted from the $119,000.00 to a net recorded balance of $91,000.00. The market value would then become $100,000.00 while the new lower barrier of the recorded balance is $81,900.00 and the upper barrier is $113,750.00.

| | |
|---|---|
| Market Value | $128,000.00 |
| Previous recorded balance | $122,000.00 |
| Realized loss | $(3,000.00) |
| Withdrawal | $(28,000.00) |
| New recorded balance | $91,000.00 |
| Market Value | $100,000.00 |
| New lower barrier | $81,900.00 |
| New upper barrier | $113,750.00 |

Following the previous example, if the investor has in his account positions that allow him to reinvest the dividends paid and/or wishes to maintain in the account the interest paid from fixed income securities, these amounts will be added to the recorded balance. In the previous example, a withdrawal of $28,000 caused a loss of $3,000.00. But if along with that, a dividend of $275.00 is paid and reinvested in the account, and an interest payment of $125.00 is maintained also in the account for a total of $400.00, the new recorded balance is $91,400.00, since the dividend and interest payments are added to the previous recorded balance of $122,000.00, first taking the balance to a net of $122,400.00. The loss of $3,000.00 is subtracted from the $122,400.00 to a net of $119,400.00. Then the $28,000.00 is subtracted from the $119,400.00 to a net recorded balance of $91,400.00. The market value would then be $100,400.00 while the new lower barrier of the recorded balance is $82,260.00 and the upper barrier is $114,250.00.

| | |
|---|---|
| Market Value | $128,000.00 |
| Previous recorded balance | $122,000.00 |
| Dividends and interest reinvested | $400.00 |
| Realized loss | $(3,000.00) |
| Withdrawal | $(28,000.00) |
| New recorded balance | $91,400.00 |
| Market Value | $100,400.00 |
| New lower barrier | $82,260.00 |
| New upper barrier | $114,250.00 |

At this point the investor is aware that his recorded balance is $91,400.00 but can decide that he wants to reset his recorded balance.

If the current market value is $100,000.00, in order to potentially help protect this gain, the investor may ask the advisor to reset the recorded balance to $100,000. Accordingly, the advisor can ask the investor if he still wants his upper and lower barriers to stay in effect or to be changed, at which point the investor can modify the barriers to his account. For example, if the investor wants to be notified when the account value of his investments falls below 5% of his recorded balances and also be notified of increases of over 15% of recorded balances, then these new thresholds or barriers are coded into the account. The new recorded balance is now $100,000.00 and the market value is $100,000.00. The new lower barrier of the recorded balance is $95,000.00 and the upper barrier is $115,000.00.

| | |
|---|---|
| Market Value | $100,000.00 |
| Previous recorded balance | $91,400.00 |
| New recorded balance (client directed) | $100,000.00 |
| New lower barrier | $95,000.00 |
| New upper barrier | $115,000.00 |

Assuming that the account market value increases to $128,000.00 again, the investor may agree with the advisor that he wants to rebalance the entire account. The investor may instruct the advisor to sell the entire account balance. This event will bring the new recorded balance to $128,000.00. The market value is $128,000.00. The new lower barrier of the recorded balance is $115,200.00 and the upper barrier is $160,000.00. Upon executing the sale of existing holdings, the investor has recorded a new balance that will track his progress going forward.

| | |
|---|---|
| Market Value | $128,000.00 |
| Previous recorded balance | $100,000.00 |
| New recorded balance | $128,000.00 |
| New lower barrier | $115,200.00 |
| New upper barrier | $160,000.00 |

The investor also has the option of adding multiple lower barriers and multiple upper barriers that may trigger different events going forward. Such events may include automatic transmissions of e-mail and/or generation of a letter to the client advising alerting that the first barrier has been reached along with a notification to the financial professional and the financial firm's logging system. A second e-mail or letter may be sent when the second barrier is reached along with the appropriate notification to the financial professional and financial firm. These notifications will automatically be recorded in the firm's records as well as in the client's accounts.

A simplified formula for describing the process described above is represented as follows:

RB=[(D+i**+div**+rg)−(W−rl))](+ or −)MVa;

where, RB=recorded balance

D=Deposits*

i=interest*

div=dividends*

rg=realized gains

W=withdrawals*

rl=realized losses

MVa=Market value adjustments (this will be applied if a hard reset is applied to the account). *It is important to note that withdrawals, deposits, dividends and interest alone, will never trigger an alert in accordance with one embodiment. They will only affect the recorded balance (interest and dividends will not affect the recorded balance if they are not reinvested into the account.). These are normal activities within an account.**Only if reinvested into the account.

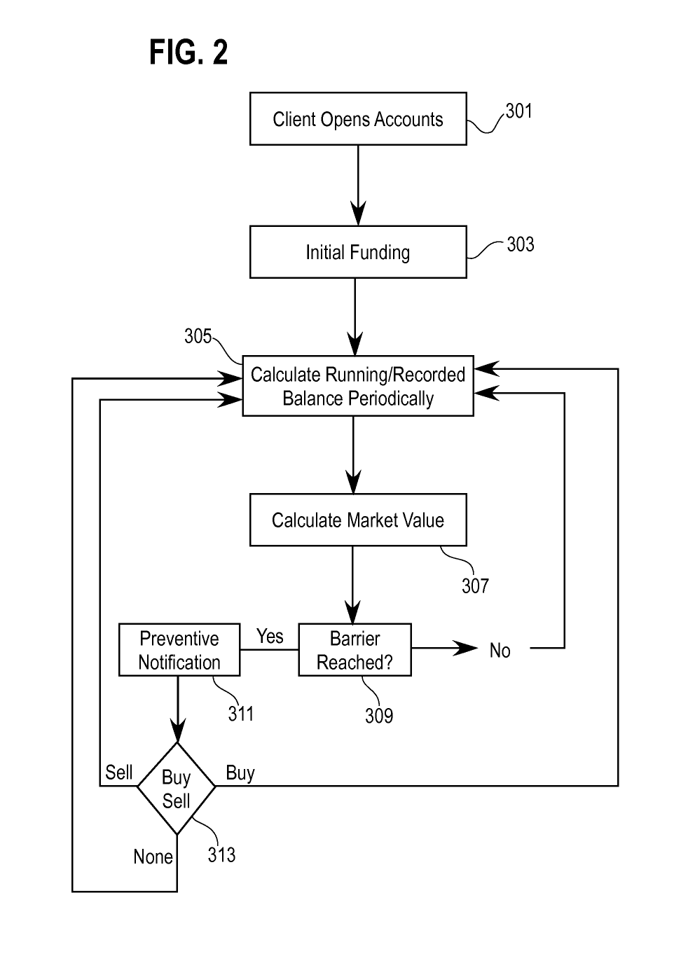

FIG. 2 illustrates a flowchart of the method of the present invention in accordance with one embodiment. At step 301 the client opens one or more accounts. At step 303 the account or accounts are initially funded. At step 305 a running or recorded balance is calculated for the account or for aggregated accounts. The recorded balance changes according to market fluctuations and is periodically calculated, in accordance with one embodiment. At the time that the accounts are opened, the client, the advisor may set upper and lower barrier percentages, as explained above. In another embodiment, the upper and lower barrier percentages may be set as default values. In yet another embodiment, these barriers may be changed after the accounts are opened. The upper and lower percentages are applied to the an initial recorded balance to calculate barrier amounts (in currency value as opposed to percentages). In step 309 the barrier amounts are compared to the running balance to determine whether a barrier amount has been reached. Step 307 includes calculation of a market value.

If a barrier has been reached, then a preventive notification is generated at step 311. The client may decide to buy or sell securities in step 313. Regardless of the action that is taken, once barriers are met, the barrier amounts may be recalculated based on the set barrier percentages applied to the current recorded balance (step not shown).

The system of the present invention can be used as a stand alone system or integrated into a financial services' firm, customized for the firm's platform. This system will enable firms to combine different investment strategies such as (for approved accounts) option trading upon specific positions or stocks reaching a predetermined level as well as program buying or selling within accounts that are deemed suitable and or have requested such programs.

There are many benefits resulting from the implementation of the system of the present invention. For example, use of the system of the present invention will provide the investing public with increased investing confidence, timely communications, and investment control and actionable items. Also, use of the present invention will provide the financial professional with a dynamic notification system which is customizable to client needs, a customizable e-mail notification for every client, global e-mail notification, and greater predictability and client retention.

Use of the present invention will also result in increased productivity for financial firms. For example, it can provide a detailed documentation of all transactions and alerts, updated daily reporting and logging, “action taken” updates, and lower litigation/arbitration costs.

Investing should generally be done on a long term basis yet there are investors that would benefit from and/or feel more comfortable with a system that will act on their behalf in uncertain economic conditions. The public confidence will be enhanced knowing that by use of the present invention a financial institution now has monitoring capabilities over the investors accounts, which are currently available. The system of the present invention will further increase awareness, not only because of the periodic notifications, but also as a result of the logging of such into account statements. These conversations and actions taken will prove to save billions of dollars lost due to market fluctuations affecting the US economy and abroad.

The foregoing description of possible implementations consistent with the present invention does not represent a comprehensive list of all such implementations or all variations of the implementations described. The description of only some implementation should not be construed as an intent to exclude other implementations. For example, artisans will understand how to implement the invention in many other ways, using equivalents and alternatives that do not depart from the scope of the invention. Moreover, unless indicated to the contrary in the preceding description, none of the components described in the implementations are essential to the invention. It is thus intended that the specification and examples be considered as exemplary only, with a true scope and spirit of the invention being indicated by the following claims.

What is claimed is:

1. The method of active monitoring of an investment portfolio, the method comprising:
calculating a recorded balance for a plurality of individual investments within the investment portfolio;
generating a at least one upper threshold and a lower threshold;
periodically applying said upper and lower thresholds to the recorded balance as the recorded balance varies to calculate upper threshold and upper threshold amounts;
monitoring fluctuations in the recorded balance against the upper and lower threshold amounts; and
generating a preventive notification when the recorded balance exceeds the upper threshold amount or goes below the lower threshold amount.

2. The method of claim 1, wherein calculating a recorded balance for an investment comprises accounting for deposits, withdrawals, market value adjustments, dividends, interest, realized gains, or realized losses.

3. The method of claim 1, wherein the notification may be generated automatically, manually, or a combination thereof.

4. The method of claim 3, wherein the notification is sent to the client.

5. The method of claim 3, wherein the notification is sent to a financial advisor.

6. The method of claim 1, wherein the upper and lower thresholds are generated based on criteria set by the client or the financial advisor.

7. The method of claim 1, wherein the upper and lower thresholds are generated based on default criteria.

8. The method of claim 1, further comprising logging a plurality of events.

9. The method of claim 8, wherein the logging of the plurality of events is configured by a client.

10. The method of claim 1, further comprising the generation of a second upper threshold and a second lower threshold.

11. A computer program product, comprising a computer usable medium having a computer readable program code embodied therein, said computer readable program code adapted to be executed to implement a method of active monitoring of an investment portfolio, said method comprising:
calculating a recorded balance for a plurality of individual investments within the investment portfolio;
generating a at least one upper threshold and a lower threshold;
periodically applying said upper and lower thresholds to the recorded balance as the recorded balance varies to calculate upper threshold and upper threshold amounts;
monitoring fluctuations in the recorded balance against the upper and lower threshold amounts; and
generating a preventive notification when the recorded balance exceeds the upper threshold amount or goes below the lower threshold amount.

12. The computer program product of claim 11, wherein calculating a recorded balance for an investment comprises accounting for deposits, withdrawals, market value adjustments, dividends, interest, realized gains, or realized losses.

13. The computer program product of claim 11, wherein the notification may be generated automatically, manually, or a combination thereof.

14. The computer program product of claim 13, wherein the notification is sent to the client.

15. The computer program product of claim 13, wherein the notification is sent to a financial advisor.

16. The computer program product of claim 11, wherein the upper and lower thresholds are generated based on criteria set by the client or the financial advisor.

17. The computer program product of claim 11, wherein the upper and lower thresholds are generated based on default criteria.

18. The computer program product of claim 11, further comprising logging a plurality of events.

19. The computer program product of claim 18, wherein the logging of the plurality of events is configured by a client.

20. The computer program product of claim 11, further comprising the generation of a second upper threshold and a second lower threshold.
